(19) United States
(12) Patent Application Publication
(10) Pub. No.: US 2011/0010868 A1
(43) Pub. Date: Jan. 20, 2011

(54) Trowel roofing knife

(76) Inventor: Vinent Palladino, Anaheim, CA (US)

Correspondence Address: RUTH EURE, 4795 EDISON AVENUE, BOULDER, CO, 80301, US

(21) Appl. No.: 12/804,322

(22) Filed: Jul. 20, 2010

Related U.S. Application Data
(60) Provisional application No. 61/271,390, filed on Jul. 20, 2009.

(51) Int. Cl. B26B 11/00

(52) U.S. Cl. 7/158

(57) ABSTRACT

The present invention provides an improved roofing knife comprising an additional blade added to the end of the knife which renders the knife more useful as a tool, safer and increases the reach of the knife. The additional blade added to the end of the knife renders the task easier and more productive. The additional blade on the end allows removal of the excess tar without the need to locate and retrieve an additional tool. The Trowel Roofing Knife is able to complete jobs necessary for utility knives, while also providing an extendable blade that facilitates the spreading of material into hot asphalt while also allowing users to easily and safely remove impurities from hot tar., the Trowel Roofing Knife is a specially designed tool configured for use with roofing knives that turns the tool into a trowel and a spreader, combining several implements into one convenient unit.

### CLAIM OF PRIORITY

This patent application claims priority under 35 USC 119 (e) (1) from U.S. Provisional Patent Application Ser. No. 61/271,390 filed Jul. 20, 2009, of common inventorship herewith entitled, “Trowel Roofing Knife.”

### Field of the Invention

The present invention pertains to the field of hand tools and more specifically to the field of roofing tools and even more specifically to the field of dual purpose roofing tools, such as a trowel roofing knife.

### BACKGROUND OF THE INVENTION

The prior art has put forth several designs for roofing tools and combination tools.

Among these are:

U.S. Pat. No. 3,708,881 to Robert A. Bennett is related to a multi-position adjustable roofing knife. This device does not incorporate a trowel.

U.S. Pat. No. 5,852,840 to Levi S. Lapp describes a knife and tacking device. This device has a knife at one end and a hammer at the other end.

U.S. Pat. No. 5,894,624 to Philip Fulenwider describes a painter's tool incorporating a putty knife at one end and a brush at the other end.

None of these prior art references describe the present invention.

### SUMMARY OF THE INVENTION

It is an object of the present invention to provide an improved roofing tool incorporating a roofing knife at one end and a trowel at the opposite end.

### BRIEF DESCRIPTION OF THE DRAWING

FIG. 1 shows perspective views of three variations of the roofing knife and trowel of the present invention.

### DETAILED DESCRIPTION OF THE INVENTION

The roofs of most buildings, especially homes, at some point in time, require repair or replacement. Whether a small leak caused by deterioration in the underlayment, a major gap in the roof resulting from a severe storm, or overall damage caused by years of exposure, work to repair or replace an existing roof cannot be started until old or damaged roofing materials are first removed and discarded.

Typically, the professional roofer will pry free the designated tiles and shingles, as well as any installation hardware and underlayments, before attempting to install the new roofing material. As such, a variety of tools are necessary to complete both the demolition of the existing roofing, as well as the proper installation of new materials. Not surprisingly, most professional roofers carry a small arsenal of tools with them when installing or repairing roofing. In particular, a specially configured knife, is an absolute necessity utilized by roofers. Unfortunately, because of the various types of materials and tasks a roofer must complete, trowels and spreaders are also needed to augment the knife. As can be imagined, repeatedly switching between several tools, all while precariously perched atop a steep, sloping roof, can be quite challenging. Further, the weight and bulk of these tools can not only weigh down a tool belt, but can also encumber the roofer's movement and speed.

The present invention addresses some of these challenges and is hereinafter referred to as the Trowel Roofing Knife. Simply stated, the Trowel Roofing Knife is a specially designed tool configured for use with roofing knives that turns the tool into a trowel and a spreader, combining several implements into one convenient unit.

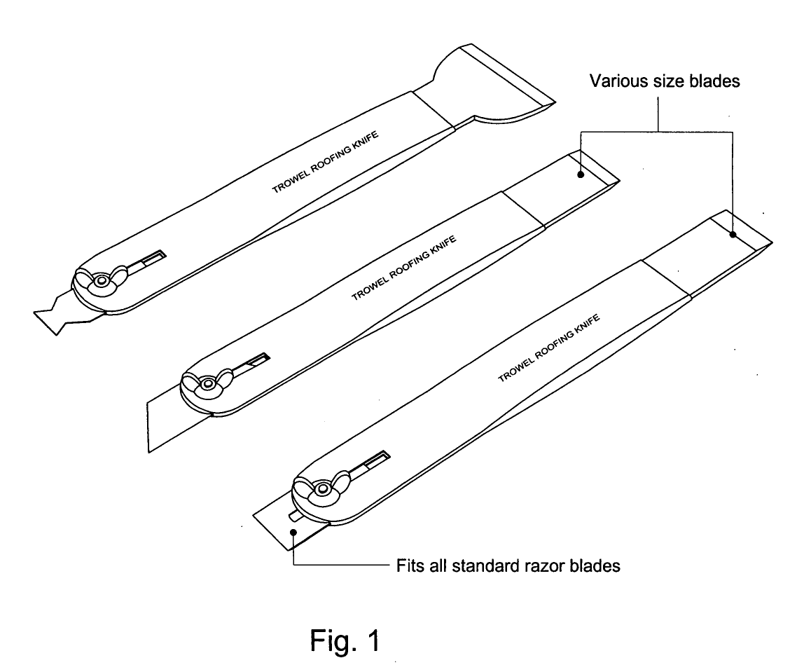

The Trowel Roofing Knife comprises an elongate handle having two ends, one or both of which can accommodate interchangeable blades. The blade comprises any suitable blade such as straight knife blade, angled knife blade, a spreading blade, a trowel blade, a notched blade, or any other geometric configuration suitable for use in roofing. A variety of blades can be seen in FIG. 1.

In roofing, the typical roofing knife is small and not very durable. In use, the end wears off quickly. This renders the knife of little value in a short period of time. The present invention provides an additional blade added to the end of the knife. This renders the knife more useful as a tool, safer and increases the reach of the knife.

While roofing with hot tar or cold tar downward pressure is applied to the layers of felt into the tar. The additional blade added to the end of the knife of the present invention renders the task easier and more productive. The additional blade on the end allows removal of the excess tar without the need to locate and retrieve an additional tool.

The knife of the present invention is more useful than the typical roofing knife. It is stronger and safer and can do many more jobs than prior art roofing knives.

The Trowel Roofing Knife is thus able to complete jobs necessary for utility knives, while also providing an extendable blade that facilitates the spreading of material into hot asphalt while also allowing users to easily and safely remove impurities from hot tar. The Trowel Roofing Knife, with several tools in one, facilitates safety while reducing the time and effort necessary to complete various tasks. Designed expressly for use by professional roofers, the Trowel Roofing Knife also serves a wide variety of useful functions and thus will also be well received by contractors and household do-it-yourselfers alike.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved roofing knife comprising an elongate handle having a blade end and a trowel end.

2. The knife of claim 1 wherein the blade end is a straight blade and the trowel end comprises a spreader.

3. The knife of claim 1 wherein the blade end is angled and the trowel end is a spreader.

4. The knife of claim 1 wherein the blades are interchangeable.

5. The knife of claim 4 wherein the interchangeable blades and ends are held in place by use of a butterfly screw.

6. The knife of claim 1 wherein the blade end is straight and the trowel end is notched.

7. The knife of claim 1 wherein the trowel end is useful for removing hot tar.
